(19) United States
(12) Patent Application Publication
(10) Pub. No.: US 2022/0172277 A1
(43) Pub. Date: Jun. 2, 2022

(54) VIRTUALLY IMMERSIVE AND PHYSICAL DIGITAL SYSTEMS AND METHODS FOR DISPENSING PHYSICAL CONSUMER PRODUCTS

(71) Applicant: The Procter & Gamble Company, Cincinnati, OH (US)

(72) Inventors: Kenneth Shun Qiang Ang, Singapore (SG); Gloria Yu Hua Cheng, Singapore (SG); Shufen Fan, Singapore (SG); Enik Wei Qi Teo, Singapore (SG)

(21) Appl. No.: 17/540,334

(22) Filed: Dec. 2, 2021

Related U.S. Application Data
(60) Provisional application No. 63/120,705, filed on Dec. 2, 2020.

(51) Int. Cl. G06Q 30/06; G06Q 20/18; G06Q 30/02; G06F 3/01; G06F 3/0482; G06T 19/00

(52) U.S. Cl. CPC G06Q 30/0643; G06Q 20/18; G06Q 30/0237; G06T 2200/24; G06F 3/0482; G06T 19/006; G06F 3/011

(57) ABSTRACT

Virtually immersive and physical digital systems and methods are described for dispensing physical consumer products. In various aspects, such systems and methods comprise receiving, by one or more processors from an input controller of a pedestal, a first selection corresponding to a selected virtual product selected from one or more virtual rendered products as rendered on a virtually immersive GUI. Based on the first selection, first virtual immersive graphical content, comprising image frame(s) depicting the selected virtual product, is rendered on a display screen. A second selection corresponding to the selected virtual product is received from the input controller causing second virtual immersive graphical content to be rendered the display screen. The second virtual immersive graphical content comprises image frame(s) depicting the selected virtual product being virtually dispensed or provided. A physical dispenser dispenses a physical product corresponding to the selected virtual product in a location accessible to the user.

### FIELD OF THE INVENTION

The present disclosure generally relates to virtually immersive and physical digital systems and methods, and, more particularly, to virtually immersive and physical digital systems and methods for dispensing physical consumer products.

### BACKGROUND OF THE INVENTION

In an increasingly digital and crowded retail space, many companies and brands not only compete for consumer attention, but must also provide physical, real-world products in a safe and effective manner This issue is exacerbated in view of the pandemic brought on by the novel Coronavirus Disease 2019 (“COVID-19”), and other similar diseases of years past. A particularly acute issue that arises in periods of disease or shortage, is that test samples of safe and clean products, such as individually sized products, are scarce, and tend to disappear from physical store shelves, depriving consumers of safe and effective test samples. Such individual test units, or otherwise trial sizes, are critical for safe in-store trial experiences.

Traditional mechanical apparatuses, such as vending machines, may process and sell consumer articles, but such consumer articles are typically provided as full-size commercial articles, and not trial-size versions. In addition, traditional vending machines often lack the ability to educate or engage consumers in the provision of beneficial and/or safe products despite the fact that consumers tend to live in an increasingly media-driven world.

For the foregoing reasons, there is a need for virtually immersive and physical digital systems and methods for dispensing physical consumer products.

### SUMMARY OF THE INVENTION

The disclosure herein generally describes highly immersive systems and methods that provide a user (e.g., a consumer) with an experience that blends real-world products with virtual experiences. That is, the virtually immersive and physical digital systems and methods as described herein provide highly physically engaging, and also virtual, experiences to users by providing an entertaining, yet educational, immersive content that provides physical and virtual aspects of one or more brands and/or product stories while remaining safe for use in public areas, e.g., during disease states such as pandemics.

As described for various embodiments herein, virtually immersive and physical digital systems and methods comprise the dispensing of physical consumer products. In various embodiments the virtually immersive and physical digital systems and methods may include a physical touchless pedestal that may be wirelessly linked (and/or wire-linked) with an immersive 180-degree wraparound display screen to provide an immersive and/or interactive experience to a user. In some embodiments, the virtually immersive and physical digital systems and methods may comprise an audible system, such as a speaker system, that may provide audio with visual presentation depicted on the display screen. The pedestal may comprise a custom-built pedestal (i.e., custom-built for its physical environment) with the ability to communicate with computer, digital, otherwise electronic input/output signals, such as those provided by a personal computer (PC), server, and/or one or more processors thereof. The pedestal may also comprise other input controls for interacting with the users including but limited to voice command input controls for voice interaction with users, Lidar and/or motion sensors to trigger content and interactive elements upon detection of motion from the users, and combinations thereof. The hardware of the pedestal may include input control(s) to allow the user to control the user's immersive experience. In some embodiments, the input control(s) may comprise a touchless control system or input controller that can detect input from consumers. As used herein, the term “control system” and “input controller” are used interchangeably. The input control(s) of an input controller may allow a user to select different virtual “stories,” which may comprise digital video and/or frames depicting brands or products for a user to learn more about. Such virtual stories may provide users with a contactless payment system to receive payment for a product. A mock contactless payment system may also be provided to simulate payment for a product and for businesses to learn customer purchase intent. In addition, a pedestal may be wirelessly connected (e.g., via BLUETOOTH and/or WIFI wireless standards) or over a wide area network (e.g., via a mobile network, i.e. 4G+/5G network, a mobile telephone network, a public switched telephone network, a satellite network, the internet, etc.) to one or more processors (e.g., a personal computer (PC)). Additionally, or alternatively, the pedestal may be connected via a wired connection.

In various embodiments, one or more processors (e.g., such as one or more processors of a PC) may be configured to execute, implement, or otherwise run software or instructions of the virtually immersive and physical digital systems and methods, e.g., for purposes of receiving user input, displaying frames, dispensing products, or otherwise as described herein. For example, software instructions may be configured to display or play preset content (e.g., videos or image frames) corresponding to each of the brands/product experiences (e.g., “stories” as described herein) upon selection of such products by a user. For example, the stories may comprise digital images or frames (e.g. a video) that comprises a visual narrative that illustrates a product to be dispensed; or, additionally or alternatively, a product dispensed at or near the same time that a physical product is dispensed.

In various embodiments, the pedestal may include a physical dispenser, or other such dispensing mechanism, configured to dispense one or more products (e.g., as selected from the virtual presentation). For example, the virtual presentation may be shown on a display screen with corresponding graphic(s) or image(s) of the product being dispensed from the physical dispenser thereby providing an intuitive and/or interactive user experience. In various embodiments, the physical dispenser may comprise a mechanical dispenser configured to release products contained in one or more capsules. The physical dispenser may also comprise other forms of electromechanical systems configured for dispensing the products, including but not limited to piezoelectric driven dispensing systems. The physical dispenser may also comprise, or be connected with, a storage area for storing capsules. Additionally or alternatively, the storage area may be located in the dispenser. Such storage area may be configured to hold a maximum number of capsules, e.g., 30 capsules. It is to be understood that fewer or greater numbers of capsules for storage in the storage area are contemplated herein.

In additional embodiments, a virtually immersive and physical digital system may comprise a mobile app based system, where products are provided or dispensed, e.g., via shipment of a capsule or otherwise (e.g., a package), following interaction of a virtual media product experience via a display screen of a mobile phone.

In various embodiments, the capsules as described herein may contain products, trial samples, coupons, or other items or things as described herein. In addition, in various embodiments, the capsules may comprise a “gashapon” or “gachapon,” which are, e.g., vending machine-dispensed containers or capsules that can contain products. However, it is to be understand that products, such as any of the products described herein, may be dispensed in an actual form as well (e.g., a makeup container or lipstick tube), without a capsule or a gachapon.

In various embodiments, virtually immersive and physical digital methods may comprise providing a consumer product that may comprise one or more of: receiving a first input from a user; selecting a consumer product displayed on a display at a first location; displaying a first product content related to the consumer product; sending a first request for input to purchase the product; receiving a second input for purchase of the product; displaying a second product content related to a product delivery process at a second location different from the first location; and/or providing the product to the user. Fewer or additional steps may also comprise a virtually immersive and physical digital method, including any of those described herein.

Generally, the present disclosure describes virtually immersive and physical digital systems and methods that enable consumers to engage in media-rich, product testing and trials, that are both safe and accessible, and that allow consumers to make product purchase decisions without risking safety or health (e.g., without touching or handling products that would have been touched by other consumers, and/or going to the store), while at the same time seeking out meaningful experiences while engaging with the system. Various benefits arise from the disclosed systems and methods herein. For example, the virtually immersive and physical digital systems and methods provide interactive, premium experiences that engages users to allow such users to learn more about given products and brands. The virtually immersive and physical digital systems and methods provide attractive and engaging experiences that current trial based platforms fail to deliver. In addition, the virtually immersive and physical digital systems and methods further provide the ability to educate and share brand and/or product stories in a novel and attractive fashion. Such stories provide a user with an opportunity to learn how product is made and/or other information about the product. Additionally, or alternatively, such stories, and/or graphic otherwise associated with a product, may provide a user with an option to purchase a related product.

In addition, the virtually immersive and physical digital systems and methods allow a fully, or mostly, contactless solution that can be effective during a disease state, such as during (or after) COVID-19, especially in retail environments. The input or control system may be touchless, which may comprise a touchless touchpad where the user can make selections by hovering a hand or finger over the touchpad.

More specifically, as described herein, in accordance with various embodiments, a virtually immersive and physical digital system is disclosed that is configured to dispense physical consumer products. In various embodiments, the virtually immersive and physical digital system may comprise a pedestal comprising an input controller configured for manipulation by a user. The virtually immersive and physical digital system may further comprise a display screen configured to render a virtually immersive graphic user interface (GUI) comprising one or more virtually rendered products. The virtually immersive and physical digital system may further comprise a physical dispenser configured to dispense one or more physical products corresponding to the one or more virtually rendered products. The virtually immersive and physical digital system may further comprise one or more processors communicatively coupled to the input controller, the display screen, and the physical dispenser. The virtually immersive and physical digital system may further comprise computing instructions accessible by the one or more processors and stored on a non-transitory computer-readable medium. The computing instructions, when executed by the one or more processors, may cause the one or more processors to (a) receive, from the input controller, a first selection corresponding to a selected virtual product selected from the one or more virtual rendered products as rendered on the virtually immersive GUI. The computing instructions, when executed by the one or more processors, may further cause the one or more processors to (b) render, based on the first selection, first virtual immersive graphical content on the display screen. The first virtual immersive graphical content comprises one or more image frames depicting the selected virtual product. The computing instructions, when executed by the one or more processors, may further cause the one or more processors to (c) receive, from the input controller, a second selection corresponding to the selected virtual product. The second selection may be received during or after rendering of the first virtual immersive graphical content. The computing instructions, when executed by the one or more processors, may further cause the one or more processors to (d) render, based on the second selection, second virtual immersive graphical content on the display screen. The second virtual immersive graphical content may comprise one or more image frames depicting the selected virtual product being virtually dispensed or provided. The computing instructions, when executed by the one or more processors, may further cause the one or more processors to (e) dispense, via the physical dispenser, a physical product corresponding to the selected virtual product in a location accessible to the user.

In addition, as described herein and in accordance with various embodiments, a virtually immersive and physical digital method is disclosed for dispensing physical consumer products. The virtually immersive and physical digital method may comprise: (a) receiving, by one or more processors from an input controller of a pedestal, a first selection corresponding to a selected virtual product selected from one or more virtual rendered products as rendered on a virtually immersive GUI. The virtually immersive GUI may be rendered on a display screen. The virtually immersive and physical digital method may further comprise: (b) rendering, by the one or more processors based on the first selection, first virtual immersive graphical content on the display screen, the first virtual immersive graphical content comprising one or more image frames depicting the selected virtual product. The virtually immersive and physical digital method may further comprise: (c) receiving, by the one or more processors from the input controller, a second selection corresponding to the selected virtual product. The second selection may be received during or after rendering of the first virtual immersive graphical content. The virtually immersive and physical digital method may further comprise: (d) rendering, by the one or more processors based on the second selection, second virtual immersive graphical content on the display screen, the second virtual immersive graphical content may further comprise one or more image frames depicting the selected virtual product being virtually dispensed or provided. The virtually immersive and physical digital method may further comprise: (e) dispensing, by the one or more processors via a physical dispenser, a physical product corresponding to the selected virtual product in a location accessible to the user.

Still further, as described herein and in accordance with various embodiments, a virtually immersive and physical digital system is disclosed that is configured to dispense physical consumer products. The virtually immersive and physical digital system comprises a mobile application (app) configured to render a virtually immersive graphic user interface (GUI) on a display screen of a mobile device. The virtually immersive GUI may comprise one or more virtually rendered products. The virtually immersive and physical digital system may comprise a server, having one or more processors, communicatively coupled to the mobile app via a computer network. The server further comprising computing instructions accessible by the one or more processors and stored on a non-transitory computer-readable medium. The computing instructions, when executed by the one or more processors, may cause the one or more processors to: (a) receive, from the mobile app, a first selection corresponding to a selected virtual product selected from the one or more virtual rendered products as rendered on the virtually immersive GUI. The computing instructions, when executed by the one or more processors, may further cause the one or more processors to: (b) render, based on the first selection, first virtual immersive graphical content on the display screen. The first virtual immersive graphical content may comprise one or more image frames depicting the selected virtual product. The computing instructions, when executed by the one or more processors, may further cause the one or more processors to: (c) receive, from the mobile app, a second selection corresponding to the selected virtual product. The second selection may be received during or after rendering of the first virtual immersive graphical content. The computing instructions, when executed by the one or more processors, may further cause the one or more processors to: (d) render, based on the second selection, second virtual immersive graphical content on the display screen. The second virtual immersive graphical content may comprise one or more image frames depicting the selected virtual product being virtually dispensed or provided. The computing instructions, when executed by the one or more processors, may further cause the one or more processors to: (e) dispense or provide a physical product corresponding to the selected virtual product to the user.

In accordance with the above, and with the disclosure herein, the present disclosure includes improvements in computer functionality or in improvements to other technologies at least because the disclosure includes, e.g., a virtually immersive and physical digital computer system that can provide virtually immersive content (image frames) to various display screens, thereby reducing the memory storage requirements compared to systems that store such image frames separately. That is, the present disclosure describes improvements in the functioning of the computer itself or “any other technology or technical field” because a virtually immersive and physical digital computer system reuses image frames as provided to a local display screen (e.g., wrap-around screen) in embodiments comprising a pedestal, as well as to a mobile display screen in embodiments comprising a mobile device. This improves over the prior art at least because the a virtually immersive and physical digital computer system uses less computer memory in storing image frames that may be used across different or various systems.

The present disclosure relates to improvement to other technologies or technical fields at least because the present disclosure describes virtually immersive and physical digital systems and methods for dispensing physical products that includes a unique physical dispenser configured to dispense physical products synchronized to immersive video content (e.g., image frames).

The present disclosure includes applying the certain of the disclosed features with, or by use of, a particular machine, e.g., including one or more of a pedestal with input controls as described herein; a display screen configured to render a virtually immersive graphic user interface (GUI) comprising one or more virtually rendered products to be dispensed, as described herein; and/or a unique physical dispenser configured to dispense physical products synchronized to immersive video content (e.g., image frames), as described herein.

The present disclosure includes specific features other than what is well-understood, routine, conventional activity in the field, or adding unconventional steps that confine the claim to a particular useful application, e.g., virtually immersive and physical digital systems and methods for dispensing physical consumer products.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1A illustrates an example virtually immersive and physical digital system in accordance with various embodiments disclosed herein.

FIG. 1B illustrates a further example of the virtually immersive and physical digital system of FIG. 1A in accordance with various embodiments disclosed herein.

FIG. 1C illustrates an example illustration of a control system of the virtually immersive and physical digital system of FIGS. 1A and 1B, in accordance with various embodiments disclosed herein.

FIG. 1D illustrates an example virtually immersive and physical digital system comprising a mobile application (app) and a server in accordance with various embodiments disclosed herein.

FIG. 2 illustrates example virtual immersive graphical content as renderable via a virtually immersive graphic user interface (GUI) of the virtually immersive and physical digital systems of FIGS. 1A, 1B and/or 1D, in accordance with various embodiments disclosed herein.

FIG. 3A illustrates a cross section view of a physical dispenser of the virtually immersive and physical digital system of FIGS. 1A and 1B, in accordance with various embodiments disclosed herein.

FIG. 3B illustrates a further cross section view of the physical dispenser of FIG. 3A, in accordance with various embodiments disclosed herein.

FIG. 4 illustrates an example flow diagram illustrating an example virtually immersive and physical digital method in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

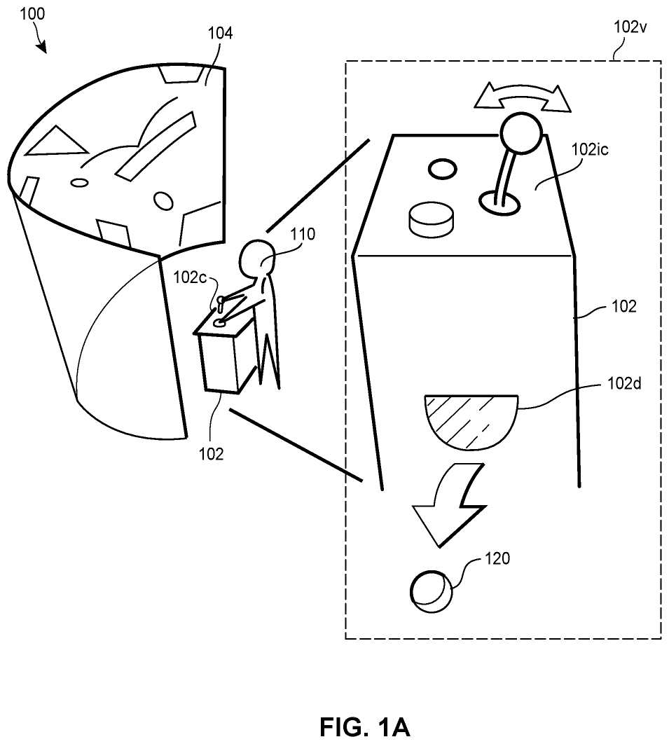

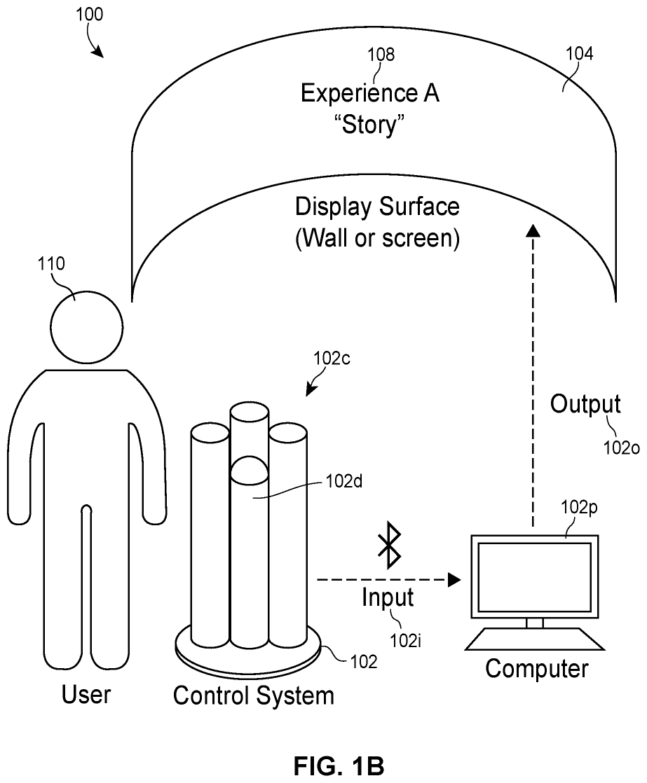

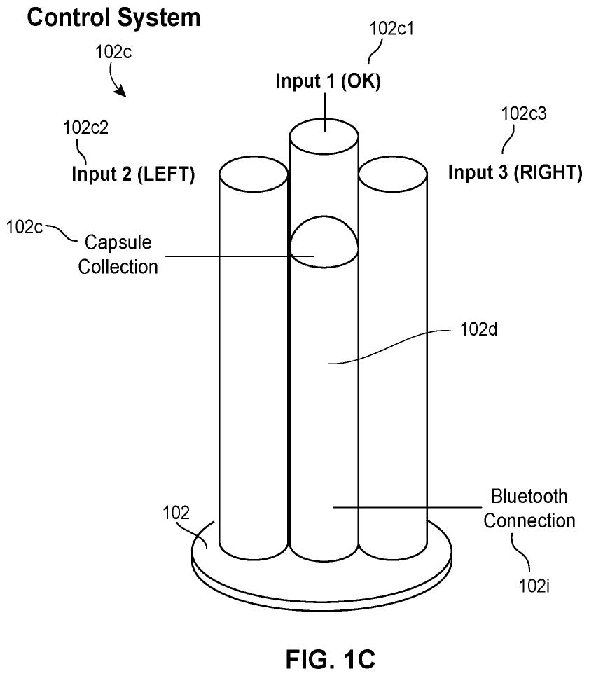

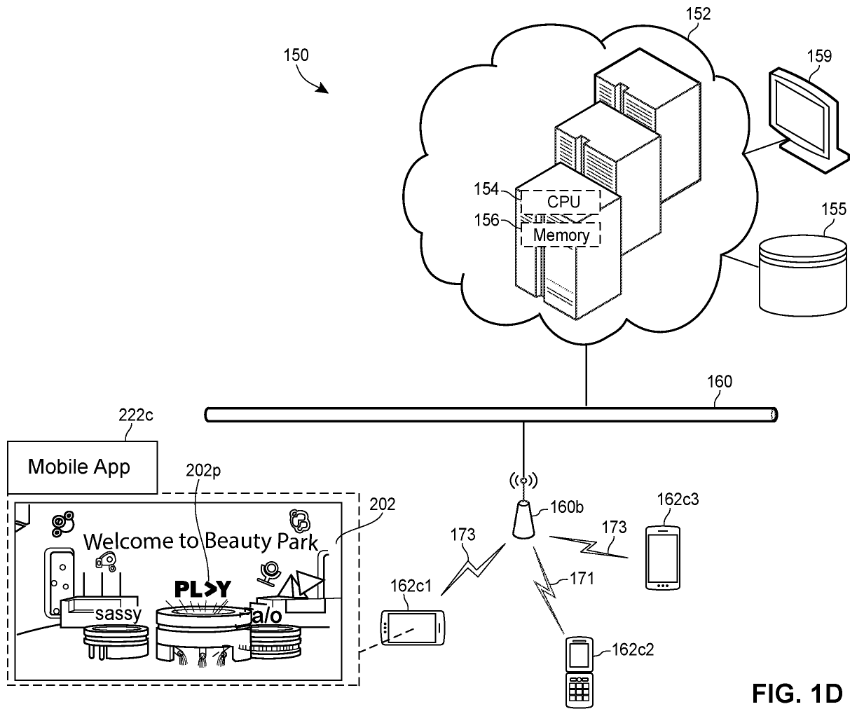

FIG. 1A illustrates an example virtually immersive and physical digital system 100 in accordance with various embodiments disclosed herein. In various embodiments ,the virtually immersive and physical digital system 100 is configured to dispense physical consumer products. For example, in the embodiment of FIG. 1A, a consumer product is depicted as dispensed in a capsule 120, which, may be a gachapon.

As shown in the example of FIG. 1A, the virtually immersive and physical digital system 100 comprises a pedestal 102. FIG. 1A shows pedestal 102 in a scaled view and also in a zoomed view 102v. Pedestal 102 includes an input controller 102c configured for manipulation by a user 110. In some embodiments, the input controller 102c includes touch-based controllers (e.g., including a joy-stick, buttons, knobs, or other such touch-based inputs). Additionally, or alternatively, input controller 102c may comprise a touchless control panel configured to detect one or more selections of the user. For example, the touchless control panel may comprise a touchscreen with sensors that can detect input as a user hovers his or her hand and/or finger above a surface of a screen or sensor of input controller 102c.

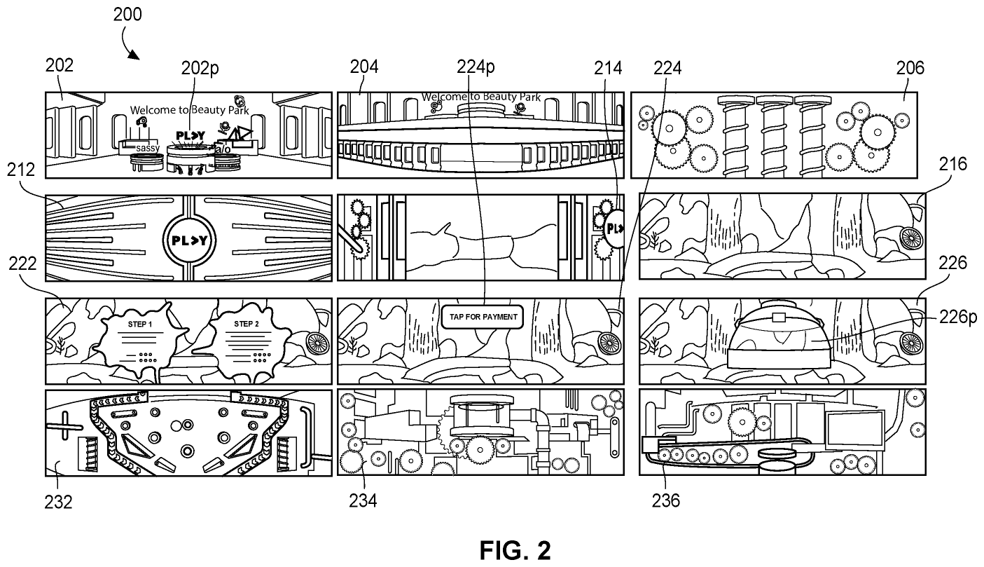

As shown in the example of FIG. 1A, virtually immersive and physical digital system 100 may further comprise a display screen 104 configured to render a virtually immersive graphic user interface (GUI) comprising one or more virtually rendered products (e.g., as described herein with respect to FIG. 2). In some embodiments, for example, including as shown in the example of FIG. 1A, display screen 104 may be a curved or a wrap-around screen that is configured to enclose, or at least face, at least a portion of the pedestal (e.g., pedestal 102) to thereby provide an immersive experience to user 110. For example, at least in some embodiments, as illustrated for FIG. 1A, the user is provided with a virtually immersive experience when virtually immersive and physical digital system 100 is positioned, or implemented, in a room, or otherwise environment, where display screen 104 is of a sufficient size to fill a user's field of vision, e.g., via a curved display. In this way, the curved display provides a feel of immersion (e.g., where there is little or nothing outside of the user's view of display screen 104 to distract the user's attention). Such configuration enhances a user's feeling of motion and engagement. Additionally, or alternatively, virtual reality, augmented reality, and/or high definition (HD) image frames may be provided to a display screen to provide the user with immersive experience(s).

In some embodiments, virtually immersive and physical digital system 100 may comprise a sound device configured to emit an audible recording corresponding to a virtual product, as rendered on the display screen 104, during a period when at least a portion of virtual immersive graphical content is rendered on the display screen 104. In such embodiments, the virtual product may correspond to a physical product or capsule (e.g., capsule 120) being dispensed, or that is to be dispensed, as described herein.

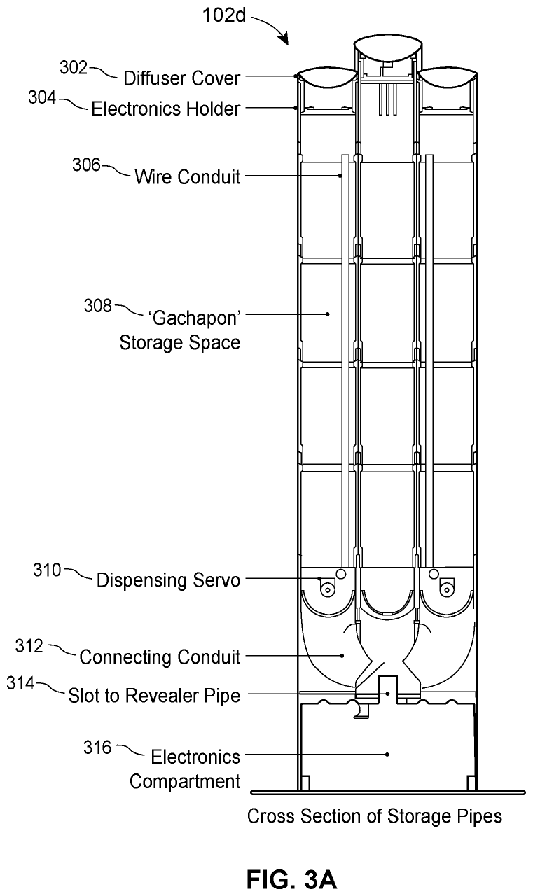

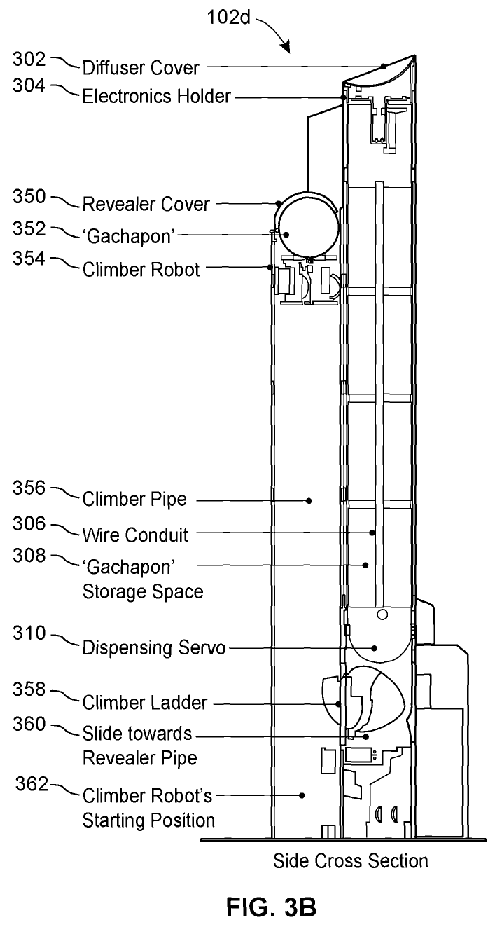

As shown in the example of FIG. 1A, virtually immersive and physical digital system 100 may further comprise a physical dispenser 102d configured to dispense one or more physical products (e.g., a product contained in capsule 120) corresponding to the one or more virtually rendered products, e.g., as displayed on display screen 104. In the embodiment of FIG. 1A, physical dispenser 102d may be at least partially covered by pedestal 102. For example, in some embodiments physical dispenser may be contained within, or at least partially within, pedestal 102. In other embodiments, physical dispenser may be separate from pedestal 102. In still further embodiments, e.g., as illustrated for FIGS. 3A and 3B, physical dispenser 102d is configured to dispense a physical product from an opening located at a top portion of the physical dispenser 102d. Physical dispenser 102d is further illustrated and described herein with respect to FIGS. 3A and 3B herein.

In the example of FIG. 1A, a consumer product is depicted as dispensed in capsule 120, which, in some embodiments, may be a gachapon. In some embodiments, the physical product comprises a product sample. Additionally or alternatively, the physical product may comprise a coupon for a consumer product. Still further, additionally or alternatively, the physical product, e.g., as dispensed from physical dispenser 102d, may comprises a machine readable optical label that contains information for obtaining a consumer product.

FIG. 1B illustrates a further example of the virtually immersive and physical digital system 100 of FIG. 1A in accordance with various embodiments disclosed herein. For example, FIG. 1B includes pedestal 102 comprising input controller 102c. In FIG. 1B, pedestal 102 is shown without a complete external covering.

FIG. 1B illustrates a flow diagram illustrating computing inputs (e.g., 102i) and outputs (e.g., 102o) as received and processed by the one or more processors associated with virtually immersive and physical digital system 100. For example, virtually immersive and physical digital system 100 includes computer 102p that comprises one or more processors configured to receive and/or process inputs (e.g., 102i) and outputs (e.g., 102o) of virtually immersive and physical digital system 100. The one or more processors may be processors as manufactured, installed, and/or provided by INTEL, AMD, APPLE, and/or ARM.

As illustrated in FIG. 1B, the one or more processors of computer 102p may be communicatively coupled to input controller 102c, display screen 104, and physical dispenser 102d. In some embodiments, the one or more processors of the computer 102p may be co-located with the input controller 102c, display screen 104, and/or physical dispenser 102d. In other embodiments, the one or more processors of computer 102p may be located at a first location different from a second location of at least one of input controller 102c, display screen 104, and/or physical dispenser 102d. Accordingly, virtually immersive and physical digital system 100 may be flexibly configured for installation, implementation, or otherwise configuration in a room, environment, and/or at different, and sometimes remote, locations.

Computer 102p may comprise computing instructions, application(s), or code that may be stored on a computer usable storage medium of computer 102p, such as a memory, e.g., a tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processor(s) of computer 102p to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

In various embodiments, the one or more processors of computer 102p may be communicatively coupled to at least one of the input controller, the display screen, or the dispenser via a wireless connection. Either of input 102i and/or output 102o may be provided a wired digital and/or electric signal, such as supplied via an Ethernet cable, universal serial bus (USB) cable, or other such cable or wire. Additionally, or alternatively, either of input 102i and/or output 102o may be provided a wireless connection, such as via BLUETOOTH or WIFI (802.11) wireless protocols or standards. The one or more processors of computer 102p may execute or implement computing instructions accessible by the one or more processors of the computer and stored on a non-transitory computer-readable medium of computer 102p, as described herein, in order to receive and/or process inputs (e.g., 102i) and outputs (e.g., 102o) of virtually immersive and physical digital system 100.

Input 102i may comprise electronic or digital signals generated or created when user 110 interacts otherwise manipulates input controller 102c. As shown in the example of FIG. 1B, input 102i may be a signal input implementing the BLUETOOTH wireless standard. However, it is to be understood, that additional and/or different standards may be used, including for example, WIFI (802.11), or, additionally or alternatively, wired signals.

Output 102o may comprise digital images, frames, and/or video for rendering on display screen 104. Output 102o may be provided wirelessly or wired from computer 102p to display screen 104. For example, “Experience A” 108 may comprise a “story” (as also described herein with respect to FIG. 2) as provided via output 102o and that includes one or more images or frames that provide a virtually immersive experience when rendered on display screen 104. In the embodiment of FIG. 1B, display screen 104 may comprise a display surface such as wall or screen (e.g., wrap-around or curved) screen, or other surface of an environment in which the virtually immersive and physical digital system 100 is implemented, positioned, or otherwise configured.

FIG. 1C illustrates an example illustration of a control system 102c of the virtually immersive and physical digital system 100 of FIGS. 1A and 1B, in accordance with various embodiments disclosed herein. In particular, FIG. 1C illustrates control system 102c as depicted in FIG. 1B, which illustrates a pedestal 102 illustrated at least partially without a cover.

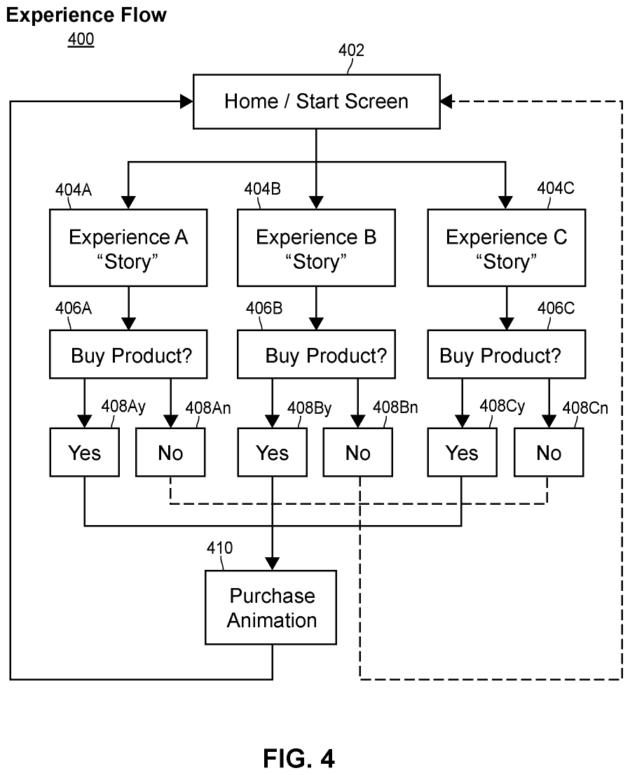

In the embodiment of FIG. 1C, control system 102c comprises various inputs 102c1, 102c2, and 102c3, each of which may be touch-based and/or touchless inputs that may be manipulated or otherwise accessed by a user (e.g., user 110). For example, in the embodiment of FIG. 1C, input 102c1 comprises an “OK” input that allows a user to select an option or item, e.g., as presented on display screen 104, for example as described in FIGS. 2 and 4 herein. Input 102c2 comprises a “LEFT” input that moves a frame or image, or selects an option, selection or selector, or otherwise graphic, as displayed on the display screen 104, to or on the left in 2D or 3D space. Similarly, input 102c3 comprises a “RIGHT” input that moves a frame or image, or selects an option, selection or selector, or otherwise graphic, as displayed on the display screen 104, to or on the right in 2D or 3D virtual space. The user's (e.g., user 110) input selections may cause control system 102c to provide input (e.g., 102i) to one or more processors (e.g., processor(s) of computer 102p), for example, as described herein for FIG. 1B, in order to manipulate and/or control the virtually immersive and physical digital system 100 as described herein.
FIG. 1C further illustrates a capsule collection area 120c from which a capsule 120, or other physical product or item, as described herein, may be dispensed from physical dispenser 102d.

FIG. 1D illustrates an example virtually immersive and physical digital system 150 comprising a mobile application (app) 222c, configured to execute or run on one or more mobile devices 162c1-162c3, and a server 152 in accordance with various embodiments disclosed herein. System 150 of FIG. 1D comprises a virtually immersive and physical digital system 150 for dispensing physical consumer products, as described herein with respect to FIGS. 1A-1C, however, the display screen of FIG. 1D is a display screen of a mobile device (e.g., mobile device 162c1). For example, in some embodiments, server 152, may be, or may be communicatively coupled to, computer 102p. In this way, computer 102p and/or server 152 may efficiently share or reuse virtually immersive content (image frames) that may be distributed to various display screens (e.g., display screen 104) or a display screen of a mobile device (e.g., mobile device). Accordingly, disclosure herein with respect to computer 102p may apply, at least with respect to some embodiments, to server 152 and vice-versa.

In the example of FIG. 1D, mobile app 222c is configured to render a virtually immersive graphic user interface (GUI) on a display screen of mobile device 162c1. The virtually immersive GUI may comprise one or more virtually rendered products that may correspond to a physical product, as described herein, e.g., for example, as described for any one or more of FIGS. 1A, 1B, 1C and/or 2.

In the example of FIG. 1D, virtually immersive and physical digital system 150 comprises server 152 communicatively coupled to mobile app 222c via a computer network 160. Virtually immersive and physical digital system 150 includes server(s) 152, which may comprise one or more computer servers. In various embodiments server(s) 152 comprise multiple servers, which may comprise multiple, redundant, or replicated servers as part of a server farm. In still further embodiments, server(s) 152 may be implemented as cloud-based servers, such as a cloud-based computing platform. For example, server(s) 152 may be any one or more cloud-based platform(s) such as MICROSOFT AZURE, AMAZON AWS, or the like. Server(s) 152 may include one or more processor(s) 154 as well as one or more computer memories 156. Server 152 server comprises one or more processor(s) (e.g., CPU 154) to execute computing instructions and/or access images, frames, and/or data. The one or more processors may be processors as manufactured and/or provided by INTEL, AMD, APPLE, and/or ARM.

Memories 156 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memorie(s) 156 may store an operating system (OS) (e.g., Microsoft Windows, Linux, UNIX, etc.) capable of facilitating the functionalities, apps, methods, or other software as discussed herein. The memories 156 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be configured to facilitate their various functionalities discussed herein. It should be appreciated that one or more other applications may be envisioned and that are executed by the processor(s) 154.

The processor(s) 154 may be connected to the memories 156 via a computer bus responsible for transmitting electronic data, data packets, or otherwise electronic signals to and from the processor(s) 154 and memories 156 in order to implement or perform the machine readable instructions, methods, processes, elements or limitations, as illustrated, depicted, or described for the various flowcharts, illustrations, diagrams, figures, and/or other disclosure herein.

The processor(s) 154 may interface with the memory 156 via the computer bus to execute the operating system (OS). The processor(s) 154 may also interface with the memory 156 via the computer bus to create, read, update, delete, or otherwise access or interact with the data stored in the memories 156 and/or the database 155 (e.g., a relational database, such as Oracle, DB2, MySQL, or a NoSQL based database, such as MongoDB). The data stored in the memories 156 and/or the database 155 may include all or part of any of the data or information described herein, including, for example, images, frames, and/or video, and the like.

The server(s) 152 may further include a communication component configured to communicate (e.g., send and receive) data via one or more external/network port(s) to one or more networks or local terminals, such as computer network 160 and/or terminal 159 (for rendering or visualizing) described herein. In some embodiments, server(s) 152 may include a client-server platform technology such as ASP.NET, Java J2EE, Ruby on Rails, Nodejs, a web service or online API, responsive for receiving and responding to electronic requests. The server(s) 152 may implement the client-server platform technology that may interact, via the computer bus, with the memories(s) 156 (including the applications(s), component(s), API(s), data, etc. stored therein) and/or database 155 to implement or perform the machine readable instructions, methods, processes, elements or limitations, as illustrated, depicted, or described for the various flowcharts, illustrations, diagrams, figures, and/or other disclosure herein. According to some embodiments, the server(s) 152 may include, or interact with, one or more transceivers (e.g., mobile network transceivers (for example, 4G/5G network transceivers) WWAN, WLAN, and/or WPAN transceivers) functioning in accordance with IEEE standards, 3GPP standards, or other standards, and that may be used in receipt and transmission of data via external/network ports connected to computer network 160. In some embodiments, computer network 160 may comprise a private network or local area network (LAN). Additionally, or alternatively, computer network 160 may comprise a public network such as the Internet.

Server(s) 152 may further include or implement an operator interface configured to present information to an administrator or operator and/or receive inputs from the administrator or operator. As shown in FIG. 1D, an operator interface may provide a display screen (e.g., via terminal 159). Server(s) 152 may also provide I/O components (e.g., ports, capacitive or resistive touch sensitive input panels, keys, buttons, lights, LEDs), which may be directly accessible via or attached to server(s) 152 or may be indirectly accessible via or attached to terminal 159. According to some embodiments, an administrator or operator may access the server 152 via terminal 159 to review information, make changes, input data or images, and/or perform other functions.

As described above herein, in some embodiments, server(s) 152 may perform the functionalities as discussed herein as part of a “cloud” network or may otherwise communicate with other hardware or software components within the cloud to send, retrieve, or otherwise analyze data or information described herein.

In general, a computer program or computer based product, application, or code, as described herein, may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 154 (e.g., working in connection with the respective operating system in memories 156) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 1D, server(s) 152 are communicatively connected, via computer network 160 to the one or more mobile devices 162c1-162c3 via base station 160b. In some embodiments, base station 160b may comprise a cellular base station, such as a cell tower, communicating to the one or more mobile devices 162c1-162c3 via wireless communications 171 based on any one or more of various mobile phone standards, including NMT, GSM, CDMA, UMMTS, LTE, 5G, or the like. Additionally or alternatively, base station 160b may comprise a router, wireless switch, or other such wireless connection points communicating to the one or more mobile devices 162c1-162c3 via wireless communications 173 based on any one or more of various wireless standards, including by non-limiting example, IEEE 802.11a/b/c/g (WIFI), the BLUETOOTH standard, or the like.

Any of the one or more mobile devices 162c1-162c3 may comprise mobile devices and/or client devices for accessing and/or communications with server(s) 152. In various embodiments, mobile devices 162c1-162c3 may comprise a cellular phone, a mobile phone, a tablet device, a personal data assistance (PDA), or the like, including, by non-limiting example, an APPLE iPhone or iPad device or a GOOGLE ANDROID based mobile phone or tablet. The one or more mobile devices 162c1-162c3 may implement or execute an operating system (OS) or mobile platform such as APPLE's iOS and/or GOOGLE' s ANDRIOD operating system. Any of the one or more mobile devices 162c1-162c3 may comprise one or more processors and/or one or more memories for storing, implementing, or executing computing instructions or code, e.g., a mobile application, as described in various embodiments herein.

Mobile devices 162c1-162c3 may comprise a wireless transceiver to receive and transmit wireless communications 171 and/or 173 to and from base station 160b. Images, frames, and/or video may be transmitted via computer network 160 from server(s) 152 for display on a mobile device (e.g., a mobile device 162c1). Each of the one or more user computer devices 162c1-162c3 may include a display screen for displaying graphics, images, text, product recommendations, data, pixels, features, and/or other such visualizations or information as described herein. In various embodiments, graphics, images, text, product recommendations, data, pixels, features, and/or other such visualizations or information may be received from server(s) 152 for display on the display screen of any one or more of user computer devices 162c1-162c3. Additionally, or alternatively, a user computer device (e.g., mobile device) may comprise, implement, have access to, render, or otherwise expose, at least in part, an interface or a guided user interface (GUI) for displaying text and/or images on its display screen.

Server 152 comprises computing instructions accessible by processor (e.g., CPU 154). Such computing instructions may be stored on a non-transitory computer-readable medium (e.g., memory 156 and/or database 155).

Referring to the example of FIG. 1D, the computing instructions (e.g., as stored on memory 156), when executed by one or more processor(s) (e.g., CPU 154), cause the one or more processor(s) (e.g., CPU 154) to receive, from mobile app 222c, a first selection corresponding to a selected virtual product selected from the one or more virtual rendered products as rendered on the virtually immersive GUI of a display screen of mobile device 162c1.

Referring to the example of FIG. 1D, the computing instructions (e.g., as stored on memory 156), when executed by one or more processor(s) (e.g., CPU 154), cause the one or more processor(s) (e.g., CPU 154) to render, based on the first selection, first virtual immersive graphical content (e.g., image 202) on the display screen, the first virtual immersive graphical content comprising one or more image frames depicting the selected virtual product. Image 202 comprises a portion of a “story” (as also described herein with respect to FIG. 2).

Referring to the example of FIG. 1D, the computing instructions (e.g., as stored on memory 156), when executed by one or more processor(s) (e.g., CPU 154), cause the one or more processor(s) (e.g., CPU 154) to receive, from mobile app 222c, a second selection corresponding to the selected virtual product, where the second selection is received during or after rendering of the first virtual immersive graphical content.

Referring to the example of FIG. 1D, the computing instructions (e.g., as stored on memory 156), when executed by one or more processor(s) (e.g., CPU 154), cause the one or more processor(s) (e.g., CPU 154) to render, based on the second selection, second virtual immersive graphical content on the display screen. The second virtual immersive graphical content comprises one or more image frames depicting the selected virtual product being virtually dispensed or provided.

In addition, referring to the example of FIG. 1D, the computing instructions (e.g., as stored on memory 156), when executed by one or more processor(s) (e.g., CPU 154), cause the one or more processor(s) (e.g., CPU 154) to dispense or provide a physical product corresponding to the selected virtual product to the user. For example, the physical product may be shipped to the user or held for the user for retrieval or dispensing a particular location. Such location information may be provided via the display screen of mobile device 162c1.

FIG. 2 illustrates example virtual immersive graphical content (e.g., image frames 202-236) as renderable via one or more virtually immersive graphic user interfaces (GUIs) of the virtually immersive and physical digital system 100 of FIGS. 1A and 1B, and/or the virtually immersive and physical digital system 150 of FIG. 1D, in accordance with various embodiments disclosed herein. For example, as described herein for FIGS. 1A and/or 1B, virtual immersive graphical content (e.g., image frames 202-236) may be provided via output 102o as one or more images or frames (e.g., a movie or animation) that provides a virtually immersive experience when rendered on display screen 104. Additionally, or alternatively, virtual immersive graphical content (e.g., image frames 202-236), as transmitted via computer network 160, may be provided to display of mobile device 162c1. Each virtual immersive graphical content (e.g., image frames 202-236) may comprises two dimensional (2D) or three dimensional (3D) image frames that each comprise various pixels and/or related data for rendering on a display screen. The virtual immersive graphical content (e.g., image frames 202-236) may be rendered in standard, high-definition, augmented reality, and/or virtual reality formats for depiction in 2D, augmented reality, and/or virtual reality on a display screen, e.g., display screen 104 and/or a display screen of mobile device 162c1. For example, display screen 104 may be a wraparound screen that provides a virtual immersive experience. Display screen on mobile device 162c1 may provide the virtual immersive experience via a 3D viewer (e.g., GOOGLE CARDBOARD), or may simply provide 2D images that offer a graphic and/or feature rich experience.

In the embodiment of FIG. 2, virtual immersive graphical content (e.g., image frames 202-236) comprises a visual “story” related to one or more physical products, product coupons, or items as described herein. For example, the “story” can demonstrate, illustrate, educate, or otherwise show one or more features, qualities, or otherwise aspects of a physical product to a user. For example, the product may be a cosmetic product (e.g., makeup, lipstick, moisturizer, or the like), a personal hygiene product (e.g., toothpaste, shampoo, deodorant, etc.), a household product (e.g., a laundry detergent product), etc. Also, other products and/or product types, such as any physical product, or product sample, a coupon, etc., capable of fitting within a capsule are contemplated herein. For example, in the embodiment of FIG. 2, a “story” or experience may involve “Beauty Park” that may correspond to at least an experience or story regarding a moisturizer product. Each of the frames 202-236 may play in a sequence, or other ordering, once the user makes a selection on a menu item (e.g., by pressing play button 202p) on a display screen (e.g., display screen 104) using input controller (e.g., input controller 102c). In various embodiments, a story (e.g., as provided by virtual immersive graphical content, e.g., image frames 202-236) may comprise an experience flow that provides dynamic and interactive experience via a display screen, based on a user's choice of product, to interact with (e.g., a moisturizer product). The experience flow can comprise a payment screen and end screen that virtually corresponds to the user's collection of the physical product from the dispenser as described herein.

The display screen, via the GUI, may render all or a portion the virtual immersive graphical content relating to the physical product. For example, in the embodiment of FIG. 2, once a user presses play button 202p from image frame 202p, each of image frames 204, 206, 212, 214, 216, 222, and 224 may be rendered on the display screen (e.g., display screen 104).

In some embodiments, and as shown via image frame 222, the user may be presented with a selectable menu item 224p for payment or selection. Selection of the menu item 224p causes image frames 226, 232, 234, and 236 (e.g., which together comprises an animation, video, e.g., a purchase animation) to be rendered on the display screen (e.g., display screen 104) corresponding to dispensing of the physical product. For example, the physical product may be dispensed in a capsule (e.g., capsule 120) that looks the same or similar to the virtual capsule 226p in image frame 226, and the animation of image frames 226, 232, 234, and 236 may show a virtual representation of the real-world physical capsule 120 being dispensed.

FIG. 3A illustrates a cross section view of a physical dispenser 102d of the virtually immersive and physical digital system 100 of FIGS. 1A and 1B, in accordance with various embodiments disclosed herein. As shown in the example of FIG. 3A, physical dispenser 102d includes a diffuser cover 302 for dispersing air or gas that may be used in ejecting or otherwise dispensing a capsule (e.g., capsule 120) from physical dispenser 102d. Electronic holder 304 may actuate diffuser cover 302 in ejecting or otherwise dispensing a capsule (e.g., capsule 120). Wire conduit 306 may support the dispensing of capsule (e.g., capsule 120) and/or may provide electrical signals to electronic holder 304 and/or diffuser cover 302 to eject or otherwise dispense a capsule (e.g., capsule 120) from physical dispenser 102d.

Capsules (e.g., “gachapons” such as capsule 120) may be held in storage space 308 (e.g., “gachapon” storage space). Dispensing servo 310 provides control and positioning of capsules stored in physical dispenser 102d. Slot to revealer pipe 314 provides a cavity within physical dispenser 102d to move capsules (e.g., physical dispenser 102). Electronics compartment 316 houses electronics components for receiving and/or provide electrical control signals (e.g., input 102i and/or output 102o) to control physical dispenser 102d for ejecting or otherwise dispensing a capsule (e.g., capsule 120).

Electronics compartment 316 may be communicatively coupled to computer 102p and may receive signals to and from computer 102p for purposes of control, input, or output of physical dispenser 102d, of virtually immersive and physical digital system 100, or as otherwise as described herein.

FIG. 3B illustrates a further cross section view of the physical dispenser 102d of FIG. 3A, in accordance with various embodiments disclosed herein. FIG. 3B depicts diffuser cover 302, electronics holder 304, wire conduit 306, storage space 308, and dispensing servo 310 as described for FIG. 4. In addition, FIG. 3B further depicts reveler cover 350 to conceal, or in some cases show (if the cover is transparent or translucent), a gachapon 352 (e.g., which may be, or be similar to, capsule 120 as described herein. Gachapon 352 may hold a physical product, product sample, coupon, or other item or thing as describe herein. FIG. 3B further depicts climber robot 354 which may be configured to move or position gachapon 352 within physical dispenser 102d. For example, climber robot 354 may be configured to move within climber pipe 356 to position gachapon 352 and/or the climber robot 354 itself at one or more positions along or with climber ladder 358. For example, climber robot 354 may move or slide gachapon 352 to reveler pipe 360 to cause gachapon 352 to be ejected or dispensed from physical dispenser 102d. Climber robot 354's starting position 362 may be positioned at the bottom of climber pipe 356. Gachapon 352 may be dispensed from physical dispenser 102d via air flowing through, and/or via mechanics (e.g., climber robot 354), of physical dispenser 102d.

FIG. 4 illustrates an example flow diagram illustrating an example virtually immersive and physical digital method 400 for dispensing physical consumer products in accordance with various embodiments disclosed herein. Method 400 may be implemented by on or by virtually immersive and physical digital system 100 (e.g., as descried herein for FIGS. 1A-1C) and/or virtually immersive and physical digital system 150 (e.g., as described herein for FIG. 1D).

FIG. 4 comprises an experience flow or flow diagram comprising more stories that include virtual immersive graphical content (e.g., image frames 202-236) as described herein for FIG. 2. For example, at block 402, a user operating or otherwise positioned in front of virtually immersive and physical digital system 100, may be initially shown a home or start screen. The home screen may depict image frame 202 of FIG. 2 that comprises a menu item (e.g., play button 202p) on a display screen (e.g., display screen 104 and/or mobile screen of mobile device 162c1). Selection of play button 202p, for example, via input controller (e.g., input controller 102c or an input provided by mobile device), may launch or start a given experience or story, e.g., any one of Experience A, Experience B, or Experience C. Each of these experiences or stories may correspond to a different, respective physical product, product sample, coupon, or other item as described herein. Such physical product, product sample, coupon, or other item may be stored in a capsule (e.g., capsule 120 and/or gachapon 352) ready to be dispensed to the user by physical dispenser 102d.

With reference to FIG. 4, execution continues from a user's selection of a given story or experience. For example, at block 404A, a user may select story or Experience A, which may correspond to a given product, e.g., moisturizer as described for FIG. 2. In such embodiment, at block 404A method 400 may comprise receiving, by one or more processors (e.g., one or more processors of computer 102p and/or CPU 154 of server 152) from an input controller (e.g., input controller 102c) of a pedestal (e.g., pedestal 102), a first selection (e.g., play button 202p) corresponding to a selected virtual product (e.g., moisturizer as virtually rendered) selected from one or more virtual rendered products as rendered on a virtually immersive GUI via a display screen (e.g., display screen 104 and/or mobile screen of mobile device 162c1).

Method 400 may further comprise rendering, by the one or more processors (e.g., one or more processors of computer 102p and/or CPU 154 of server 152) based on the first selection (e.g., play button 202p), first virtual immersive graphical content on the display screen. The first virtual immersive graphical content may comprise one or more images (e.g., image frames) depicting the selected virtual product. For example, once a user presses play button 202p from image frame 202, each of image frames 204, 206, 212, 214, 216, 222, and 224 may be rendered on the display screen (e.g., display screen 104 or a display screen of mobile device 162c1).

At block 406An, method 400 may further comprises presenting an option or otherwise graphical menu item to allow the user to not purchase the physical product or to otherwise cancel the experience or story.

At block 406A, method 400 may further comprise displaying, via a display screen (e.g., display screen 104 or a display screen of mobile device 162c1), an option to purchase or buy the physical product (e.g., moisturizer) during or after rendering of the first virtual immersive graphical content. For example, at block 406Ay, method 400 may include presenting an option or otherwise graphical menu item (e.g., a selectable menu item 224p) to allow the user to purchase the physical product or to otherwise proceed with the experience or story.

Upon a selection at block 406Ay, method 400 further comprises receiving, by the one or more processors (e.g., one or more processors of computer 102p and/or CPU 154 of server 152) from the input controller (e.g., input controller 102c or input of a mobile device), a second selection corresponding to the selected virtual product (e.g., moisturizer as rendered virtually). In such embodiments, the second selection (e.g., at block 408Ay) may be received during or after rendering of the first virtual immersive graphical content. In some embodiments, the second selection may include a request of the user to purchase the physical product and the second selection may cause the processor (e.g., one or more processors of computer 102p and/or CPU 154 of server 152) to render a payment interface on the display screen to collect payment information of the user.

Method 400 further comprises rendering, by the one or more processors (e.g., one or more processors of computer 102p and/or CPU 154 of server 152) based on the second selection (e.g., at block 408Ay), second virtual immersive graphical content on the display screen (e.g., display screen 104 or a display screen of mobile device 162c1). The second virtual immersive graphical content may comprise one or more image frames depicting the selected virtual product being virtually dispensed or provided. For example, at block 410, selection at block 408Ay (e.g., of menu item 224p) may causes image frames 226, 232, 234, and 236, as described for FIG. 2 (e.g., which together comprises an animation, video, e.g., a purchase animation), to be rendered on the display screen (e.g., display screen 104) corresponding dispensing of the physical product. A physical product may be dispensed in a capsule (e.g., capsule 120, which may comprise a gachapon as described herein for FIGS. 2, 3A, and/or 3B) such that the one or more image frames depicting the virtual product being virtually dispensed or provided includes one or more image frames depicting the virtual product being dispensed or provided via a virtual representation of the capsule. The physical product may be dispensed in a capsule (e.g., capsule 120) that looks the same or similar to the virtual capsule 226p, e.g., as shown in in image frame 226, and the animation of image frames 226, 232, 234, and 236 may show a virtual representation of the real-world physical capsule 120 being dispensed.

Additionally, in various embodiments, the one or more image frames (e.g., image frames 226, 232, 234, and 236) depicting a virtual product (e.g., moisturizer as virtually rendered) being virtually dispensed or provided may comprise one or more image frames depicting the virtual product being dispensed or provided via a virtual representation of the dispenser. For example, where one or more of the image frames (e.g., image frames 226, 232, 234, and 236) shows a virtual depiction of the physical dispenser 102d dispensing the virtual product.

Method 400 further comprises dispensing, by the one or more processors (e.g., one or more processors of computer 102p and/or CPU 154 of server 152) via a physical dispenser (e.g., physical dispenser 102d), a physical product (e.g., within capsule 120) corresponding to the selected virtual product (e.g., moisturizer) in a location accessible to the user. For example, the physical product may be a moisturizer sample in a capsule or gachapon (e.g., capsule 120) dispensed from physical dispenser 102d which is at a location of the user (e.g., in embodiments where the user is in the vicinity of virtually immersive and physical digital system 100). In embodiments involving virtually immersive and physical digital system 150, a physical product or sample may be shipped to the user or made available to the user at a pick-up location.

Blocks 404B, 406B, 408By, and 408Bn of FIG. 4 may provide a similar method, execution, or flow as described for blocks 404A, 406A, 408Ay, and 408An of FIG. 4, except for a different product, sample, etc., or, alternatively, for a same product, sample, etc., but with different image frames (e.g., thereby showing a same product with different graphics resulting in a different virtual “experience” or story). Similarly, blocks 404C, 406C, 408Cy, and 408Cn of FIG. 4 may provide a similar method, execution, or flow as described for blocks 404A, 406A, 408Ay, and 408An of FIG. 4, except for a different product, sample, etc., or, alternatively, for a same product, sample, etc., but with different image frames (e.g., thereby showing a same product with different graphics resulting in a different virtual “experience” or story).

### Aspects of the Present Disclosure

The following aspects of the disclosure are exemplary only and not intended to limit the scope of the disclosure.

1. A virtually immersive and physical digital system configured to dispense physical consumer products, the virtually immersive and physical digital system comprising: a pedestal comprising an input controller configured for manipulation by a user; a display screen configured to render a virtually immersive graphic user interface (GUI) comprising one or more virtually rendered products; a physical dispenser configured to dispense one or more physical products corresponding to the one or more virtually rendered products; one or more processors communicatively coupled to the input controller, the display screen, and the physical dispenser; and computing instructions accessible by the one or more processors and stored on a non-transitory computer-readable medium, wherein the computing instructions, when executed by the one or more processors, cause the one or more processors to: (a) receive, from the input controller, a first selection corresponding to a selected virtual product selected from the one or more virtual rendered products as rendered on the virtually immersive GUI, (b) render, based on the first selection, first virtual immersive graphical content on the display screen, the first virtual immersive graphical content comprising one or more image frames depicting the selected virtual product, (c) receive, from the input controller, a second selection corresponding to the selected virtual product, wherein the second selection is received during or after rendering of the first virtual immersive graphical content, (d) render, based on the second selection, second virtual immersive graphical content on the display screen, the second virtual immersive graphical content comprising one or more image frames depicting the selected virtual product being virtually dispensed or provided, and (e) dispense, via the physical dispenser, a physical product corresponding to the selected virtual product in a location accessible to the user.

2. The virtually immersive and physical digital system of aspect 1, wherein the physical product comprises a product sample.

3. The virtually immersive and physical digital system as in any one of aspects 1 or 2, wherein the one or more image frames depicting the virtual product being virtually dispensed or provided comprises one or more image frames depicting the virtual product being dispensed or provided via a virtual representation of the dispenser.

4. The virtually immersive and physical digital system as in any one of aspects 1-3, wherein the physical product is dispensed in a capsule, and wherein the one or more image frames depicting the virtual product being virtually dispensed or provided comprises one or more image frames depicting the virtual product being dispensed or provided via a virtual representation of the capsule.

5. The virtually immersive and physical digital system as in any one of aspects 1-4 further comprising displaying via the display screen an option to purchase the physical product during or after rendering of the first virtual immersive graphical content.

6. The virtually immersive and physical digital system as in any one of aspects 1-5, wherein the second selection comprises a request of the user to purchase the physical product, and wherein the second selection causes the one or more processors to render a payment interface on the display screen to collect payment information of the user.

7. The virtually immersive and physical digital system as in any one of aspects 1-6, wherein the input controller comprises a touchless control panel configured to detect one or more selections of the user.

8. The virtually immersive and physical digital system as in any one of aspects 1-7 further comprising a sound device configured to emit an audible recording corresponding to the virtual product during a period when at least a portion of virtual immersive graphical content is rendered on the display screen.

9. The virtually immersive and physical digital system as in any one of aspects 1-8, wherein the one or more processors are communicatively coupled to at least one of the input controller, the display screen, or the dispenser via a wireless connection.

10. The virtually immersive and physical digital system as in any one of aspects 1-9, wherein the one or more processors are at a first location different from a second location of at least one of the input controller, the display screen, or the dispenser.

11. The virtually immersive and physical digital system as in any one of aspects 1-10, wherein the display screen is a curved or wrap-around screen that is configured to enclose or face at least a portion of the pedestal.

12. The virtually immersive and physical digital system as in any one of aspects 1-11, wherein the physical product comprises a coupon for a consumer product.

13. The virtually immersive and physical digital system as in any one of aspects 1-12, wherein the physical product comprises a machine readable optical label that contains information for obtaining a consumer product.

14. The virtually immersive and physical digital system as in any one of aspects 1-13, wherein the physical dispenser is configured to dispense the physical product from an opening located at a top portion of the physical dispenser.

15. A virtually immersive and physical digital method for dispensing physical consumer products, the virtually immersive and physical digital method comprising: (a) receiving, by one or more processors from an input controller of a pedestal, a first selection corresponding to a selected virtual product selected from one or more virtual rendered products as rendered on a virtually immersive GUI, the virtually immersive GUI rendered on a display screen; (b) rendering, by the one or more processors based on the first selection, first virtual immersive graphical content on the display screen, the first virtual immersive graphical content comprising one or more image frames depicting the selected virtual product; (c) receiving, by the one or more processors from the input controller, a second selection corresponding to the selected virtual product, wherein the second selection is received during or after rendering of the first virtual immersive graphical content; (d) rendering, by the one or more processors based on the second selection, second virtual immersive graphical content on the display screen, the second virtual immersive graphical content comprising one or more image frames depicting the selected virtual product being virtually dispensed or provided; and (e) dispensing, by the one or more processors via a physical dispenser, a physical product corresponding to the selected virtual product in a location accessible to the user.

16. A virtually immersive and physical digital system for dispensing physical consumer products, the virtually immersive and physical digital system comprising: a mobile application (app) configured to render a virtually immersive graphic user interface (GUI) on a display screen of a mobile device, the virtually immersive GUI comprising one or more virtually rendered products; a server communicatively coupled to the mobile app via a computer network, the server comprising one or more processors, and the server comprising computing instructions accessible by the one or more processors and stored on a non-transitory computer-readable medium, wherein the computing instructions, when executed by the one or more processors, cause the one or more processors to: (a) receive, from the mobile app, a first selection corresponding to a selected virtual product selected from the one or more virtual rendered products as rendered on the virtually immersive GUI, (b) render, based on the first selection, first virtual immersive graphical content on the display screen, the first virtual immersive graphical content comprising one or more image frames depicting the selected virtual product, (c) receive, from the mobile app, a second selection corresponding to the selected virtual product, wherein the second selection is received during or after rendering of the first virtual immersive graphical content, (d) render, based on the second selection, second virtual immersive graphical content on the display screen, the second virtual immersive graphical content comprising one or more image frames depicting the selected virtual product being virtually dispensed or provided, and (e) dispense or provide a physical product corresponding to the selected virtual product to the user.

### Additional Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processor(s) may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept. The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A virtually immersive and physical digital system configured to dispense physical consumer products, the virtually immersive and physical digital system comprising:
a pedestal comprising an input controller configured for manipulation by a user;
a display screen configured to render a virtually immersive graphic user interface (GUI) comprising one or more virtually rendered products;
a physical dispenser configured to dispense one or more physical products corresponding to the one or more virtually rendered products;
one or more processors communicatively coupled to the input controller, the display screen, and the physical dispenser; and
computing instructions accessible by the one or more processors and stored on a non-transitory computer-readable medium, wherein the computing instructions, when executed by the one or more processors, cause the one or more processors to:
(a) receive, from the input controller, a first selection corresponding to a selected virtual product selected from the one or more virtual rendered products as rendered on the virtually immersive GUI,
(b) render, based on the first selection, first virtual immersive graphical content on the display screen, the first virtual immersive graphical content comprising one or more image frames depicting the selected virtual product,
(c) receive, from the input controller, a second selection corresponding to the selected virtual product, wherein the second selection is received during or after rendering of the first virtual immersive graphical content,
(d) render, based on the second selection, second virtual immersive graphical content on the display screen, the second virtual immersive graphical content comprising one or more image frames depicting the selected virtual product being virtually dispensed or provided, and
(e) dispense, via the physical dispenser, a physical product corresponding to the selected virtual product in a location accessible to the user.

2. The virtually immersive and physical digital system of claim 1, wherein the physical product comprises a product sample.

3. The virtually immersive and physical digital system of claim 1, wherein the one or more image frames depicting the virtual product being virtually dispensed or provided comprises one or more image frames depicting the virtual product being dispensed or provided via a virtual representation of the dispenser.

4. The virtually immersive and physical digital system of claim 1, wherein the physical product is dispensed in a capsule, and wherein the one or more image frames depicting the virtual product being virtually dispensed or provided comprises one or more image frames depicting the virtual product being dispensed or provided via a virtual representation of the capsule.

5. The virtually immersive and physical digital system of claim 1 further comprising displaying via the display screen an option to purchase the physical product during or after rendering of the first virtual immersive graphical content.

6. The virtually immersive and physical digital system of claim 1, wherein the second selection comprises a request of the user to purchase the physical product, and wherein the second selection causes the one or more processors to render a payment interface on the display screen to collect payment information of the user.

7. The virtually immersive and physical digital system of claim 1, wherein the input controller comprises a touchless control panel configured to detect one or more selections of the user.

8. The virtually immersive and physical digital system of claim 1 further comprising a sound device configured to emit an audible recording corresponding to the virtual product during a period when at least a portion of virtual immersive graphical content is rendered on the display screen.

9. The virtually immersive and physical digital system of claim 1, wherein the one or more processors are communicatively coupled to at least one of the input controller, the display screen, or the dispenser via a wireless connection.

10. The virtually immersive and physical digital system of claim 1, wherein the one or more processors are at a first location different from a second location of at least one of the input controller, the display screen, or the dispenser.

11. The virtually immersive and physical digital system of claim 1, wherein the display screen is a curved or wrap-around screen that is configured to enclose or face at least a portion of the pedestal.

12. The virtually immersive and physical digital system of claim 1, wherein the physical product comprises a coupon for a consumer product.

13. The virtually immersive and physical digital system of claim 1, wherein the physical product comprises a machine readable optical label that contains information for obtaining a consumer product.

14. The virtually immersive and physical digital system of claim 1, wherein the physical dispenser is configured to dispense the physical product from an opening located at a top portion of the physical dispenser.

15. A virtually immersive and physical digital method for dispensing physical consumer products, the virtually immersive and physical digital method comprising:
(a) receiving, by one or more processors from an input controller of a pedestal, a first selection corresponding to a selected virtual product selected from one or more virtual rendered products as rendered on a virtually immersive GUI, the virtually immersive GUI rendered on a display screen;
(b) rendering, by the one or more processors based on the first selection, first virtual immersive graphical content on the display screen, the first virtual immersive graphical content comprising one or more image frames depicting the selected virtual product;
(c) receiving, by the one or more processors from the input controller, a second selection corresponding to the selected virtual product, wherein the second selection is received during or after rendering of the first virtual immersive graphical content;
(d) rendering, by the one or more processors based on the second selection, second virtual immersive graphical content on the display screen, the second virtual immersive graphical content comprising one or more image frames depicting the selected virtual product being virtually dispensed or provided; and
(e) dispensing, by the one or more processors via a physical dispenser, a physical product corresponding to the selected virtual product in a location accessible to the user.

16. A virtually immersive and physical digital system for dispensing physical consumer products, the virtually immersive and physical digital system comprising:
a mobile application (app) configured to render a virtually immersive graphic user interface (GUI) on a display screen of a mobile device, the virtually immersive GUI comprising one or more virtually rendered products;
a server communicatively coupled to the mobile app via a computer network, the server comprising one or more processors, and the server comprising computing instructions accessible by the one or more processors and stored on a non-transitory computer-readable medium, wherein the computing instructions, when executed by the one or more processors, cause the one or more processors to:
(a) receive, from the mobile app, a first selection corresponding to a selected virtual product selected from the one or more virtual rendered products as rendered on the virtually immersive GUI,
(b) render, based on the first selection, first virtual immersive graphical content on the display screen, the first virtual immersive graphical content comprising one or more image frames depicting the selected virtual product,
(c) receive, from the mobile app, a second selection corresponding to the selected virtual product, wherein the second selection is received during or after rendering of the first virtual immersive graphical content,
(d) render, based on the second selection, second virtual immersive graphical content on the display screen, the second virtual immersive graphical content comprising one or more image frames depicting the selected virtual product being virtually dispensed or provided, and
(e) dispense or provide a physical product corresponding to the selected virtual product to the user.
